(19) United States
(12) Patent Application Publication
(10) Pub. No.: US 2024/0225124 A1
(43) Pub. Date: Jul. 11, 2024

(54) AEROSOL GENERATING DEVICE AND CONTROL METHOD FOR SAME

(71) Applicant: KT&G CORPORATION, Daejeon (KR)

(72) Inventor: Jae Min LEE, Gyeonggi-do (KR)

(73) Assignee: KT&G CORPORATION, Daejeon (KR)

(21) Appl. No.: 17/928,061

(22) PCT Filed: Aug. 1, 2022
(86) PCT No.: PCT/KR2022/011310

§ 371 Date: Mar. 2, 2023

(30) Foreign Application Priority Data
Aug. 27, 2021 (KR) 10-2021-0113979

(51) Int. Cl. A24F 40/57; A24F 40/51; H05B 6/10

(52) U.S. Cl. CPC A24F 40/57; A24F 40/51; H05B 6/108

(57) ABSTRACT

An aerosol generating device includes: a heater configured to heat an aerosol generating material; and a controller configured to control supply of electric power to the heater, according to a predetermined temperature profile, wherein the controller is further configured to detect puffs of a user, and change the predetermined temperature profile based on a time interval between the detected puffs.

### TECHNICAL FIELD

Embodiments of the present disclosure relate to an aerosol generating device and a control method for the same.

### BACKGROUND ART

Recently, there has been a growing demand for alternative methods of resolving problems of common cigarettes. For example, there has been a growing demand for a system that generates an aerosol by heating a cigarette or an aerosol generating material by using an aerosol generating device, rather than by burning a cigarette.

An aerosol generating device of the related art controls a heater through temperature control of a predetermined pattern and generates an aerosol regardless of a user's inhalation pattern.

### DISCLOSURE OF INVENTION

### Technical Problem

In the related art, an aerosol is generated regardless of a user's inhalation pattern, and thus, the needs of various users are not satisfied. Therefore, there is a need to provide a satisfactory feeling of smoking and taste of smoking to a user by providing a certain amount of aerosols according to the user's inhalation pattern.

Technical problems to be solved by the embodiments of the present disclosure are not limited to the above-described problems, and problems, solved by embodiments of the present disclosure, that are not mentioned will be clearly understood by those of ordinary skill in the art from the present specification and the accompanying drawings.

### Solution to Problem

An aerosol generating device according to an embodiment of the present disclosure includes a heater configured to heat an aerosol generating material and a controller configured to control supply of electric power to the heater, according to a predetermined temperature profile, wherein the controller is further configured to detect puffs of a user, and change the predetermined temperature profile based on a time interval between the detected puffs.

### Advantageous Effects of Invention

According to various embodiments of the present disclosure, a certain amount of aerosols according to a user's inhalation pattern may be provided, thereby providing a user with a satisfactory feeling of smoking and taste of smoking.

However, effects achieved by embodiments of the present disclosure are not limited to the above-described effect, and effects that are not mentioned will be clearly understood by those of ordinary skill in the art from the present specification and the accompanying drawings.

### BRIEF DESCRIPTION OF DRAWINGS

FIG. 1 is a schematic view of an aerosol generating device according to an embodiment.

FIG. 2 is a detailed schematic view of a controller shown in FIG. 1.

FIG. 3 is another detailed schematic view of a controller shown in FIG. 1.

FIG. 4 is an example view for describing a preset temperature profile.

FIG. 5 is an example view for describing changes in the temperature profile shown in FIG. 4 according to a time interval between puffs.

FIG. 6 is an example view for describing changes in the temperature profile shown in FIG. 4 according to a time interval between puffs.

FIG. 7 is an example view for describing a preset temperature profile and a temperature profile changed according to a time interval between puffs.

FIG. 8 is an example view for describing a preset temperature profile and a temperature profile changed according to a time interval between puffs.

FIG. 9 is a block diagram of an aerosol generating device according to another embodiment.

### MODE FOR THE INVENTION

With respect to the terms used to describe the various example embodiments of the present disclosure, general terms which are currently and widely used are selected in consideration of functions of structural components in the various embodiments of the present disclosure. However, meanings of the terms can be according to intention, a judicial precedence, the appearance of new technology, and the like. In addition, in certain cases, there is also a term arbitrarily selected by the applicant, in which case the meaning will be described in detail in the description of one or more embodiments. Therefore, the terms used to describe one or more embodiments should be defined based on the meanings of the terms and the general contents of one or more embodiments, rather than simply the names of the terms.

In addition, unless explicitly described to the contrary, the word “comprise” and variations such as “comprises” or “comprising” will be understood to imply the inclusion of stated components but not the exclusion of any other components. In addition, the terms “-er”, “-or”, and “module” described in the specification mean units for processing at least one function and operation and can be implemented by hardware components or software components and combinations thereof.

As used herein, when the expression, such as “at least any one of” precedes arranged components, the expression modifies all components rather than each of the arranged components. For example, the expression “at least one of a, b, and c” indicates only a, only b, only c, both a and b, both a and c, both b and c, all of a, b, and c, or variations thereof.

In an embodiment, an aerosol generating device may generate an aerosol by electrically heating a cigarette accommodated in the inner space.

The aerosol generating device may include a heater. In an embodiment, the heater may be an electrically resistive heater. For example, the heater may include an electrically conductive track, and when an electric current flows through the electrically conductive track, the heater may be heated.

The heater may include a tube-type heating element, a plate-type heating element, a needle-type heating element, or a rod-type heating element, and may heat the inside or the outside of the cigarette, according to the shape of the heating element.

The cigarette may include a tobacco rod and a filter rod. The tobacco rod may be formed as a sheet, a strand, or a pipe tobacco which is formed of tiny bits cut from a tobacco sheet. Also, the tobacco rod may be surrounded by a heat conductive material. For example, the heat conductive material may be, but is not limited to, a metal foil, such as aluminum foil.

The filter rod may include a cellulose acetate filter. The filter rod may include at least one segment. For example, the filter rod may include a first segment configured to cool an aerosol and a second segment configured to filter a certain component included in the aerosol.

In another embodiment, the aerosol generating device may generate an aerosol by using a cartridge containing an aerosol generating material.

The aerosol generating device may include a cartridge containing an aerosol generating material, and a main body supporting the cartridge. The cartridge and the main body may be attachably/detachably coupled to each other, but embodiments are not limited thereto. The cartridge and the main body may be integrally formed or assembled, and may be fixed so as not to be attached/detached by a user. The cartridge may be coupled to the main body while accommodating an aerosol generating material therein. However, embodiments are not limited thereto, and an aerosol generating material may be injected into the cartridge while the cartridge is coupled to the main body.

The cartridge may contain an aerosol generating material having any one of various states, such as a liquid state, a solid state, a gaseous state, and a gel state. The aerosol generating material may include a liquid composition. For example, the liquid composition may be a liquid including a tobacco-containing material having a volatile tobacco flavor component, or a liquid including a non-tobacco material.

The cartridge is operated by an electrical signal or a wireless signal, which is transmitted from the main body, to perform a function of generating an aerosol by converting the phase of the aerosol generating material inside the cartridge into a gaseous phase. The aerosol may refer to a gas in which vaporized particles generated from the aerosol generating material are mixed with air.

In another embodiment, the aerosol generating device may generate an aerosol by heating a liquid composition, and the generated aerosol may be transmitted to a user through the cigarette. In other words, the aerosol generated from the liquid composition may travel along an airflow passage of the aerosol generating device, and the airflow passage may allow the aerosol to be transmitted to the user through the cigarette.

In another embodiment, the aerosol generating device may generate an aerosol from an aerosol generating material by using an ultrasonic wave vibration method. In this regard, the ultrasonic wave vibration method may refer to a method of generating an aerosol by atomizing an aerosol generating material with ultrasonic wave vibration generated by a vibrator.

The aerosol generating device may include a vibrator and atomize an aerosol generating material by generating short-period vibration through the vibrator. The vibration generated by the vibrator may be ultrasonic wave vibration, and a frequency band of the ultrasonic wave vibration may be about 100 kHz to about 3.5 MHz, but embodiments are not limited thereto.

The aerosol generating device may further include a wick that absorbs an aerosol generating material. For example, the wick may be arranged to surround at least one region of the vibrator or may be arranged to be in contact with at least one region of the vibrator.

As a voltage (e.g., alternating voltage) is applied to the vibrator, heat and/or ultrasonic wave vibration may be generated from the vibrator, and the heat and/or the ultrasonic wave vibration generated from the vibrator may be transmitted to the aerosol generating material absorbed in the wick. The aerosol generating material absorbed in the wick may be converted into a gaseous phase by the heat and/or the ultrasonic wave vibration transmitted from the vibrator, and as a result, an aerosol may be generated.

For example, the viscosity of the aerosol generating material absorbed in the wick may be decreased due to the heat generated from the vibrator, the aerosol generating material with the decreased viscosity may be atomized due to the ultrasonic wave vibration generated from the vibrator, and thus, an aerosol may be generated, but embodiments are not limited thereto.

In another embodiment, the aerosol generating device may generate an aerosol by heating an aerosol generating article accommodated in the aerosol generating device in an induction heating method.

The aerosol generating device may include a susceptor and a coil. In an embodiment, the coil may apply a magnetic field to the susceptor. As electric power is supplied to the coil from the aerosol generating device, a magnetic field may be formed in the coil. In an embodiment, the susceptor may be a magnetic material that generates heat by an external magnetic field. As the susceptor is located in the coil and generates heat in response to a magnetic field being applied, the aerosol generating article may be heated. Also, alternatively, the susceptor may be located in the aerosol generating particle.

In another embodiment, the aerosol generating device may further include a cradle.

The aerosol generating device may constitute a system with a separate cradle. For example, the cradle may charge a battery of the aerosol generating device. Alternatively, the heater may be heated while the cradle and the aerosol generating device are coupled to each other.

Hereinafter, the present disclosure will be described more fully with reference to the accompanying drawings, in which non-limiting example embodiments of the present disclosure are shown such that those of ordinary skill in the art may easily work the present disclosure. Embodiments of the present disclosure includes the aerosol generating devices of the various embodiments described above and below, may be implemented in various different forms, and is not limited to the example embodiments described herein.

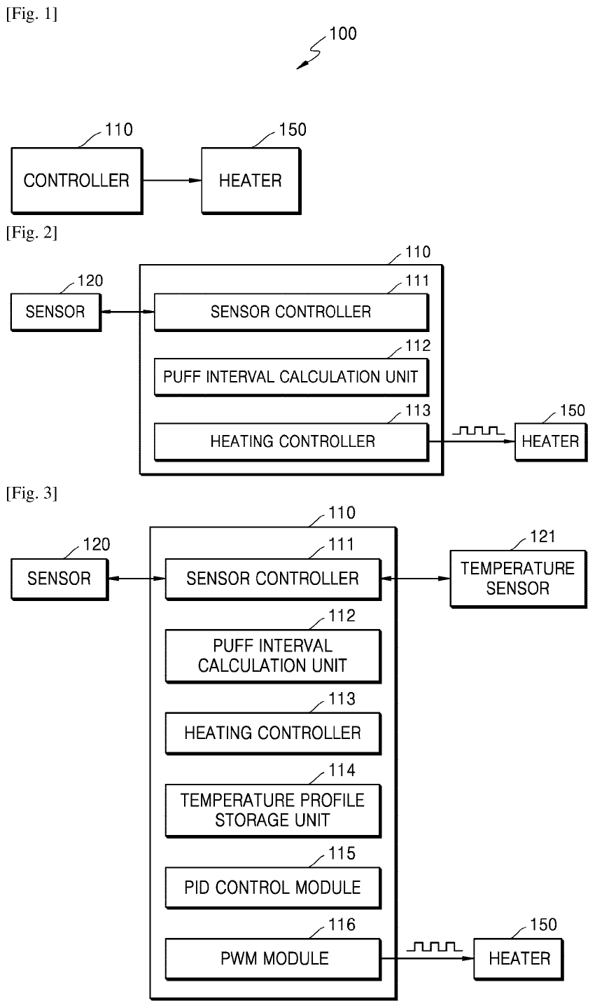

FIG. 1 is a schematic view of an aerosol generating device 100 according to an embodiment.

Referring to FIG. 1, the aerosol generating device 100 may include a controller 110 and a heater 150.

The controller 110 controls an operation of the aerosol generating device 100. The controller 110 controls supply of electric power to the heater 150 according to a predetermined temperature profile. Also, the controller 110 detects puffs of a user and changes the predetermined temperature profile based on a time interval between the detected puffs. The controller 110 controls supply of electric power to the heater 150 according to the changed temperature profile. Here, the temperature profile refer to a specification that defines a target temperature according to a time. Also, in terms of an amount of electric power supply for following the target temperature of the temperature profile, it should be understood as the same meaning as an electric power profile.

When the time interval between the puffs is less than a first threshold value, the controller 110 may follow a target temperature of the temperature profile at a second feedback control speed greater than a predetermined first feedback control speed, or when the time interval between the puffs is greater than or equal to the first threshold value, the controller 110 may follow the target temperature of the temperature profile at a third feedback control speed less than the first feedback control speed. Here, the first threshold value is a settable value, and may be a user average puff interval value.

When the time interval between the puffs is less than a second threshold value, the controller 110 may follow a target temperature corresponding to a time t−1 ahead of a time t in the temperature profile in which a target temperature according to the time t is set, or when the time interval between the puffs is greater than or equal to the second threshold value, the controller 110 may follow a target temperature corresponding to a time t+1 later than the time t. Here, the second threshold value is a settable value, and may be a user average puff interval value.

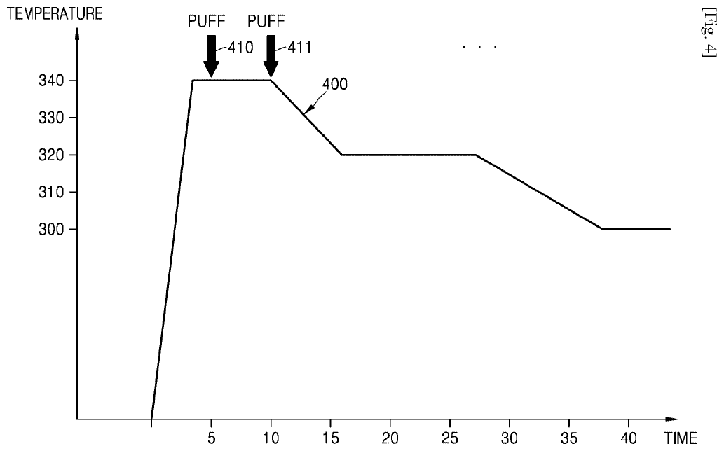

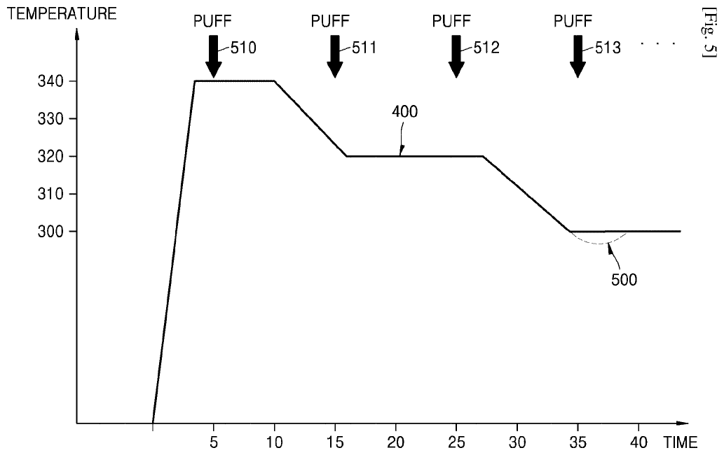

The controller 110 detects puffs of a user. The controller 110 may detect puffs of a user by monitoring a change in an amount of electric power supplied to the heater or by monitoring a change in electric power of a battery. The controller 110 may detect puffs of a user through a sensor 120 shown in FIGS. 2 and 3.

In an embodiment, the aerosol generating device 100 detects puffs of a user, and adaptively or variably changes a predetermined temperature profile according to a time interval between the puffs. Here, the changing of the temperature profile may include increasing or decreasing a feedback control speed for following a target temperature of the heater, or advancing or delaying a process of the next step of the temperature profile.

For example, when the time interval between the puffs is short, the feedback control speed may be increased so that a decrease in temperature of the heater may be minimized, and recovery of the temperature of the heater may be accelerated. Therefore, for users with a rapid inhalation pattern, the problem of dissatisfaction with a decrease in an atomization amount due to a sharp decrease in heater temperature due to frequent puffs in a short period of time may be solved. In contrast, when the time interval between the puffs is long, the feedback control speed may be decreased so that a temperature decrease may be accelerated, and recovery of the temperature of the heater may be slowed down. Therefore, for users with a slow inhalation pattern, carbonization of aerosol generating materials due to an unnecessarily long high-temperature maintenance interval, or factors that impair the taste of smoking, may be avoided.

For example, when the time interval between the puffs is short, a holding time of a high-temperature interval may be increased by delaying a process of the next step of the temperature profile, or when the time interval between the puffs is long, a holding time of a high-temperature interval may be decreased by advancing a process of the next step.

In an embodiment, the temperature profile is adaptively changed according to a user's puff pattern to control electric power, thereby reflecting smoking patterns of various users to generate and provide certain aerosols.

Here, a time interval between puffs may have the same meaning as a puff interval or a puff pattern. For example, when a user takes a second inhalation 3 seconds after a first inhalation for smoking, a time interval between puffs is 3 seconds. When another user takes a second inhalation 1 second after a first inhalation for smoking, a time interval between puffs is 1 second. When another user takes a second inhalation 5 seconds after a first inhalation for smoking, a time interval between puffs is 5 seconds. When another user takes a second inhalation 10 seconds after a first inhalation for smoking, a time interval between puffs is 10 seconds.

In an embodiment, according to a time interval between puffs of a user, a uniform feeling of smoking may be provided to all users by controlling a temperature recovery feedback speed of a predetermined temperature profile or controlling a process speed of a temperature profile.

In another embodiment, according to the length of a puff of a user or the strength of the puff, a temperature recovery feedback speed of a predetermined temperature profile may be controlled, or a process speed of a temperature profile may be controlled. For example, a duration of a puff according to one inhalation of a user may be 0.5 seconds, 1 second, or 2 seconds, and variable electric power control may be performed according to the duration of the puff. Also, variable electric power control may also be performed according to a user's inhalation amount, that is, a puff strength.

FIG. 2 is a detailed schematic view of the controller 110 shown in FIG. 1.

Referring to FIG. 2, the aerosol generating device 100 includes the sensor 120, the heater 150, and the controller 110, and the controller 110 includes a sensor controller 111, a puff interval calculation unit 112, and a heating controller 113. The aerosol generating device 100 shown in FIG. 2 detects puffs of a user through the sensor 120.

The sensor controller 111 may be a sensor integrated circuit (IC). The sensor controller 111 provides an input signal, for example, a reference voltage, to the sensor 120, and receives an output signal, for example, a sensing voltage, from the sensor 120. The sensor 120 may be a puff sensor. The puff sensor may detect a puff of a user based on various physical changes in an airflow passage or airflow channel of the aerosol generating device 100. For example, the puff sensor may detect a temperature change, a flow change, a voltage change, or a pressure change. Also, the sensor 120 may be a temperature sensor. The temperature sensor may be arranged in the heater 150 or around the heater 150 and may detect a puff when the temperature decreases.

The puff interval calculation unit 112 receives an input of a signal sensed from the sensor controller 111, detects a puff, and calculates an interval or a time interval between puffs. The puff interval calculation unit 112 may calculate a puff interval after at least two puffs after a user starts smoking. Also, the puff interval calculation unit 112 may calculate a puff interval by taking an average value of a time interval between first and second puffs and a time interval between second and third puffs after three times of puffs.

The heating controller 113 may be a heating IC that controls supply of electric power to the heater 150. The heating controller 113 may output a pulse signal for controlling on/off of an electric power control switch (not shown). The heating controller 113 may control an amount of electric power supplied to the heater 150 by outputting a pulse width modulation signal.

The heating controller 113 controls a feedback control speed for following a target temperature of the heater to be increased or decreased or a process of the next step of a temperature profile to be advanced or delayed when it is determined that a puff interval is short or long by comparing the puff interval calculated by the puff interval calculation unit 112 with a threshold value. The heating controller 113 outputs a pulse width modulation signal for varying an amount of electric power supplied to the heater 150 according to the previous control.

FIG. 3 is another detailed schematic view of the controller 110 shown in FIG. 1.

Referring to FIG. 3, the controller 110 includes the sensor controller 111, the puff interval calculation unit 112, the heating controller 113, a temperature profile storage unit 114, a proportional-integral-derivative (PID) control module 115, a pulse width modulation (PWM) module 116. Descriptions of components overlapping with the components described with reference to FIG. 2 will be omitted, and additional components will be described.

The actual temperature of the heater 150 is detected by a temperature sensor 121. The temperature sensor 121 may detect a temperature at which the heater 150 or an aerosol generating material is heated. The aerosol generating device 100 may include a separate temperature sensor that detects the temperature of the heater 150, or the heater 150 itself may serve as the temperature sensor.

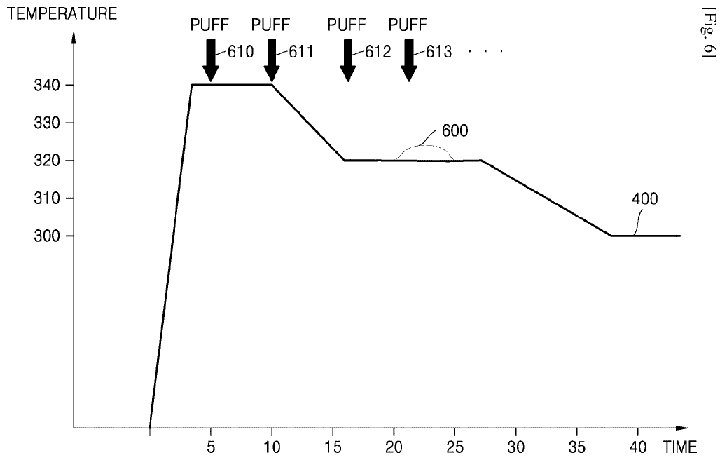

The temperature profile storage unit 114 (also referred to as “memory” or “storage”) stores a preset (also referred to as “predetermined”) temperature profile. The temperature profile may vary depending on a device usage environment of the aerosol generating device 100, for example, temperature/humidity conditions, a type of aerosol generating material, for example, a solid or liquid type, or a type of heater, for example, a resistive heater, an induction heating type heater, or an ultrasonic wave vibrator. The temperature profile will be described with reference to FIG. 4.

The PID control module 115 may control the temperature of the heater to follow a target temperature on a temperature profile by using, as a feedback input value, the actual temperature of the heater measured by the temperature sensor 121 to control the temperature of the heater 150. The PID control module 115 may control a value of a difference or error between a currently sensed actual temperature and a target temperature through proportional (P), integral (I), and derivative (D) calculations. Amplification values or gain values multiplied for proportional (P), integral (I), and derivative (D) calculations are respectively referred to as Kp, Ki, and Kd, and by adjusting these gain values, the time required by an output value to first reach a target value (rising time, tr), the time required by an output value to first reach an overshoot peak (peak time, tp), the time required by an output value to reach within an error range of a target value (settling time, ts), and the amount of an output value exceeding a target value (overshoot, Mp) are controlled.

In an embodiment, when a time interval between puffs is short, at least one of Kp, Ki, and Kd gain values of the PID control module 115 may be changed to increase a feedback control speed. For example, the time to reach the target temperature may be shortened by increasing Kp or Ki. However, the three gain values may be appropriately combined and changed by considering other factors together. In contrast, when a time interval between puffs is long, a feedback control speed may be decreased so that a temperature decrease may be accelerated, and recovery of the temperature of the heater may be slowed down. To this end, at least one of Kp, Ki, and Kd gain values of the PID control module 115 may be changed.

The PWM module 116 generates a pulse width modulation signal to control supply of electric power to the heater 150 and outputs the pulse width modulation signal to an electric power control switch (not shown). When the electric power control switch is turned on, electric power of a battery (not shown) is supplied to the heater 150. The PWM module 116 generates a pulse width modulation signal according to a heating control signal of the heating controller 113. The heating control signal may be a signal for supplying an amount of electric power to reach a target temperature at a current time point on a temperature profile.

FIG. 4 is an example view for describing a preset temperature profile.

Referring to FIG. 4, a temperature profile 400 is shown. The temperature profile is defined as temperature versus time. The aerosol generating device 100 supplies electric power to the heater to reach a preset temperature on the temperature profile over time. As shown, when the aerosol generating device is operated, the temperature of the heater is rapidly increased to about 340 degrees for preheating. For example, when preheating is completed 3 seconds to 4 seconds after the aerosol generating device is operated, a user is ready to inhale an aerosol. When the user inhales, a first puff 410 and a second puff 411 are sequentially performed. When the first puff 410 is generated at 5 seconds, an aerosol generating material is vaporized to generate an aerosol, and the user inhales the aerosol. At this time, the actual temperature of the heater may be decreased. For example, when the actual temperature of the heater is decreased by about 10 degrees and reaches 330 degrees after the first puff 410, the aerosol generating device increases the temperature of the heater to a target temperature by supplying more electric power to maintain 340 degrees which is the target temperature after 5 seconds. The aerosol generating device is configured so that the target temperature of the heater is decreased to 320 degrees for 10 seconds to 15 seconds in the temperature profile 400. When the second puff 411 is generated at 10 seconds, an aerosol generating material is vaporized to generate an aerosol, and the user inhales the aerosol. At this time, the actual temperature of the heater may be decreased again. For example, the actual temperature of the heater is decreased by about 10 degrees after the second puff 411, and the aerosol generating device supplies electric power to the heater to match a target temperature decrease rate after 10 seconds.

Aerosol generating devices of the related art are configured to follow a target temperature on a predetermined temperature profile, regardless of a time interval between puffs shown in FIG. 4. Therefore, certain aerosols suitable for a user's smoking pattern could not be provided, and thus, not all users could be satisfied.

FIG. 5 is an example view for describing changes in the temperature profile shown in FIG. 4 according to a time interval between puffs.

Referring to FIG. 5, a first puff 510, a second puff 511, a third puff 512, and a fourth puff 513 are sequentially performed according to a user's inhalation. As shown, a time interval between the first puff 510 and the second puff 511 is 10 seconds, and a time interval between the second puff 511 and the third puff 512 is 10 seconds. The aerosol generating device 100 determines that 10 seconds, which is the time interval between the puffs, is greater than or equal to a threshold value, for example, 7 seconds, and changes the preset temperature profile 400 from the fourth puff 513. A changed temperature profile 500 allows a feedback control speed to decrease after the fourth puff 513 to accelerate a temperature decrease and slow down recovery of the temperature of the heater. In other words, for users with a slow inhalation pattern, carbonization of aerosol generating materials due to an unnecessarily long high-temperature maintenance interval, or factors that impair the taste of smoking, are avoided.

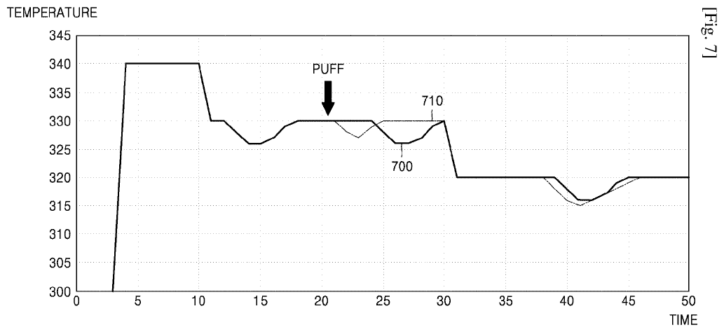

FIG. 6 is an example view for describing changes in the temperature profile shown in FIG. 4 according to a time interval between puffs.

Referring to FIG. 6, a first puff 610, a second puff 611, a third puff 612, and a fourth puff 613 are sequentially performed according to a user's inhalation. As shown, a time interval between the first puff 610 and the second puff 611 is 5 seconds, and a time interval between the second puff 611 and the third puff 612 is 5 seconds. The aerosol generating device 100 determines that 5 seconds, which is the time interval between the puffs, is less than a threshold value, for example, 7 seconds, and changes the preset temperature profile 400 from the fourth puff 613. A changed temperature profile 600 allows a feedback control speed to increase after the fourth puff 613 to minimize a decrease in temperature of the heater and accelerate recovery of the temperature of the heater. Therefore, for users with a rapid inhalation pattern, the problem of dissatisfaction with a decrease in an atomization amount due to a sharp decrease in heater temperature due to frequent puffs in a short period of time is solved.

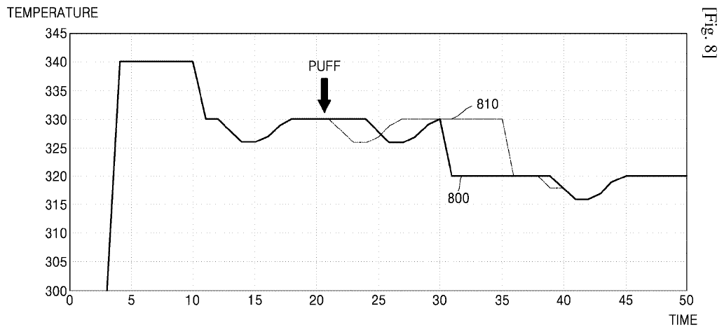

FIGS. 7 and 8 are example views for describing a preset temperature profile and a temperature profile changed according to a time interval between puffs.

Referring to FIG. 7, a preset temperature profile 700 and a temperature profile 710 changed according to a time interval between puffs are shown.

With reference to FIG. 7, the aerosol generating device 100 is operated, and after the first two or three puffs, a time interval between puffs is compared with a threshold value. In addition, when a time interval between puffs is short, a feedback control speed according to a user's puff action is increased at a fourth puff time point, that is, approximately 20 seconds, to minimize a decrease in temperature of the heater, thereby accelerating recovery of the actual temperature of the heater. In contrast, when a time interval between puffs is long, a feedback control speed is decreased so that a holding time of a high-temperature interval is shortened.

Referring to FIG. 8, a preset temperature profile 800 and a temperature profile 810 changed according to a time interval between puffs are shown.

With reference to FIG. 8, the aerosol generating device 100 is operated, and after the first two or three puffs, a time interval between puffs is compared with a threshold value. In addition, when a time interval between puffs is short, a process to the next step of the predetermined temperature profile 800 is accelerated at approximately 25 seconds, which is after the fourth puff time point, to increase a high-temperature holding time. As shown, the temperature profile is changed so that the target temperature increases to maintain the temperature of 330 degrees without a decrease in the target temperature at approximately 25 seconds. In contrast, when a time interval between puffs is long, a feedback control speed is decreased so that a holding time of a high-temperature interval is shortened.

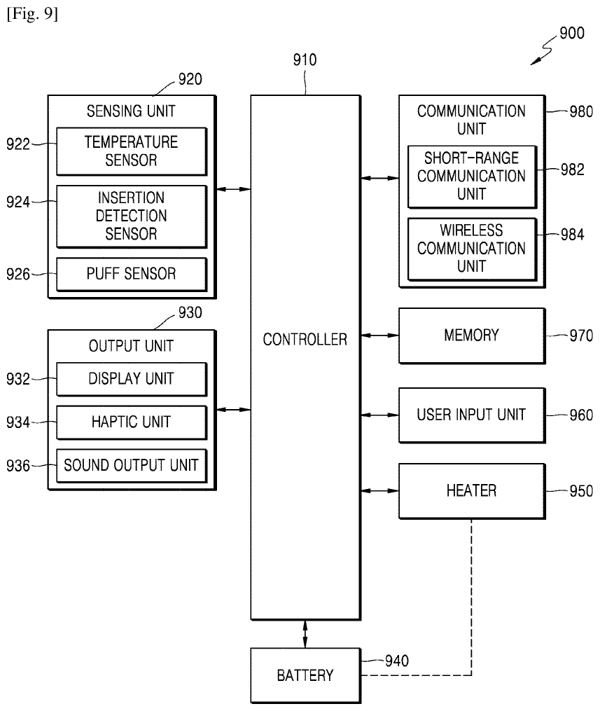

FIG. 9 is a block diagram of an aerosol generating device 900 according to another embodiment.

The aerosol generating device 900 may include a controller 910, a sensing unit 920 (also referred to as “at least one sensor”), an output unit 930, a battery 940, a heater 950, a user input unit 960 (also referred to as an “inputter”), a memory 970, and a communication unit 980. However, the internal structure of the aerosol generating device 900 is not limited to that shown in FIG. 9. In other words, in embodiments of the aerosol generating device 900, it will be understood by those of ordinary skill in the art that some of the components shown in FIG. 9 may be omitted or new components may be added.

The aerosol generating device 900 according to an embodiment detects puffs of a user, and adaptively or variably changes a predetermined temperature profile according to a time interval between the puffs. In other words, the aerosol generating device 900 may provide a consistent amount of aerosol by reflecting a user's smoking pattern by variably performing electric power control according to the user's puffing interval.

The sensing unit 920 may detect a state of the aerosol generating device 900 or a state of surrounding of the aerosol generating device 900, and may transmit the detected information to the controller 910. The controller 910 may control the aerosol generating device 900 so that various functions, such as controlling of an operation of the heater 950, restricting smoking, determining whether an aerosol generating article (for example, a cigarette, a cartridge, etc.) is inserted, displaying a notification, or the like, are performed based on the detected information.

The sensing unit 920 according to an embodiment may detect puffs of a user. A puff sensor 926 or a temperature sensor 922 may detect puffs of a user, but embodiments are not limited thereto.

The sensing unit 920 may include at least one of the temperature sensor 922, an insertion detection sensor 924, and the puff sensor 926, but embodiments are not limited thereto.

The temperature sensor 922 may detect a temperature at which the heater 950 (or an aerosol generating material) is heated. The aerosol generating device 900 may include a separate temperature sensor that detects the temperature of the heater 950, or the heater 950 itself may serve as the temperature sensor. Alternatively, the temperature sensor 922 may be arranged around the battery 940 to monitor the temperature of the battery 940.

The insertion detection sensor 924 may detect insertion and/or removal of an aerosol generating article. For example, the insertion detection sensor 924 may include at least one of a film sensor, a pressure sensor, an optical sensor, a resistive sensor, a capacitive sensor, an inductive sensor, and an infrared sensor, and may detect a signal change in response to an aerosol generating article being inserted and/or removed.

The puff sensor 926 may detect puffs of a user based on various physical changes in an airflow passage or an airflow channel. For example, the puff sensor 926 may detect puffs of a user based on any one of a temperature change, a flow change, a voltage change, and a pressure change.

The sensing unit 920 may further include at least one of a temperature/humidity sensor, a barometric pressure sensor, a magnetic sensor, an acceleration sensor, a gyroscope sensor, a location sensor (for example, a global positioning system (GPS)), a proximity sensor, and an RGB sensor (illuminance sensor), in addition to the temperature sensor 922, the insertion detection sensor 942, and the puff sensor 926. A function of each sensor may be intuitively inferred by those of ordinary skill in the art from the name, and thus, detailed descriptions may be omitted.

The output unit 930 may output information about a state of the aerosol generating device 900 and provide the information to a user. The output unit 930 may include at least one of a display unit 932, a haptic unit 934, and a sound output unit 936, but embodiments are not limited thereto. When the display unit 932 and a touch pad form a layer structure to form a touch screen, the display unit 932 may be used as an input device in addition to an output device.

The display unit 932 may visually provide information about the aerosol generating device 900 to a user. For example, the information about the aerosol generating device 900 may refer to various information, such as a charging/discharging state of the battery 940 of the aerosol generating device 900, a preheating state of the heater 950, an insertion/removal state of an aerosol generating article, or a state in which the use of the aerosol generating device 900 is restricted (for example, abnormal article detection), and the display unit 932 may output the information to the outside. The display unit 932 may be, for example, a liquid crystal display (LCD) panel or an organic light-emitting display (OLED) panel. Also, the display unit 932 may be in the form of a light-emitting diode (LED) light-emitting device.

The haptic unit 934 may tactually provide information about the aerosol generating device 900 to a user by converting an electrical signal into a mechanical stimulus or an electrical stimulus. For example, the haptic unit 934 may include a motor, a piezoelectric device, or an electrical stimulation device.

The sound output unit 936 may audibly provide information about the aerosol generating device 900 to a user. For example, the sound output unit 936 may convert an electric signal into a sound signal and output the sound signal to the outside. For example, the sound output unit 936 may be a speaker.

The battery 940 may supply electric power used to operate the aerosol generating device 900. The battery 940 may supply electric power so that the heater 950 may be heated. Also, the battery 940 may supply electric power for operations of other components (for example, the sensing unit 920, the output unit 930, the user input unit 960, the memory 970, and the communication unit 980) provided in the aerosol generating device 900. The battery 940 may be a rechargeable battery or a disposable battery. For example, the battery 940 may be a lithium polymer (LiPoly) battery, but embodiments are not limited thereto.

The heater 950 may heat an aerosol generating material by receiving electric power from the battery 940. Although not shown in FIG. 9, the aerosol generating device 900 may further include an electric power conversion circuit (for example, a DC/DC converter) that converts electric power of the battery 940 and supplies the converted electric power to the heater 950. Also, when the aerosol generating device 900 generates an aerosol in an induction heating method, the aerosol generating device 900 may further include a DC/AC converter that converts DC power of the battery 940 into AC power.

The controller 910, the sensing unit 920, the output unit 930, the user input unit 960, the memory 970, and the communication unit 980 may perform functions by receiving electric power from the battery 940. Although not shown in FIG. 9, the aerosol generating device 900 may further include an electric power conversion circuit, for example, a low dropout (LDO) circuit or a voltage regulator circuit, that converts electric power of the battery 940 and supplies the converted electric power to each component.

In an embodiment, the heater 950 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but embodiments are not limited thereto. Also, the heater 950 may be implemented by a metal wire, a metal plate on which an electrically conductive track is arranged, or a ceramic heating element, but embodiments are not limited thereto.

In another embodiment, the heater 950 may be a heater of an induction heating type. For example, the heater 950 may include a susceptor that heats an aerosol generating material by generating heat through a magnetic field applied by a coil.

The user input unit 960 may receive information input from a user, or may output the information to the user. For example, the user input unit 960 may include a key pad, a dome switch, a touch pad (e.g., using a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. Although not shown in FIG. 9, the aerosol generating device 900 may further include a connection interface, such as a universal serial bus (USB) interface, and may be connected to another external device through a connection interface, such as a USB interface, to transmit/receive information or charge the battery 940.

The memory 970 is a hardware component that stores various data processed in the aerosol generating device 900, and may store data processed or to be processed by the controller 910. The memory 970 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 970 may store an operating time of the aerosol generating device 900, a maximum number of puffs, a current number of puffs, at least one temperature profile, and data about a user's smoking pattern.

In an embodiment, the memory 970 may store a predetermined temperature profile, and may also store a temperature profile according to a user's puff pattern. In an embodiment, although it has been described that a predetermined temperature profile is changed according to a user's puff interval, a temperature profile according to a user's puff interval may also be applied.

The communication unit 980 may include at least one component for communication with another electronic device. For example, the communication unit 980 may include a short-range wireless communication unit 982 and a wireless communication unit 984. According to embodiments, the communication unit 980 may include at least one antenna.

The short-range wireless communication unit 982 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+communication unit, or the like, but is not limited thereto. According to embodiments, the short-range wireless communication unit 982 may include at least one antenna.

The wireless communication unit 984 may include a cellular network communication unit, an Internet communication unit, and a computer network (for example, local area network (LAN) or wide area network (WAN)) communication unit, but embodiments are not limited thereto. The wireless communication unit 984 may identify and authenticate the aerosol generating device 900 within a communication network by using subscriber information (for example, an international mobile subscriber identifier (IMSI)). According to embodiments, the wireless communication unit 984 may include at least one antenna.

The controller 910 may control the overall operation of the aerosol generating device 900. In an embodiment, the controller 910 may include at least one processor. The at least one processor may be implemented as an array of a plurality of logic gates or may be implemented as a combination of a general-purpose microprocessor and a memory in which a program executable in the microprocessor is stored. Also, it will be understood by those of ordinary skill in the art that the processor may be implemented in other forms of hardware. According to embodiments, the program is configured to, when executed by the microprocessor, cause the microprocessor to perform any number of the functions of the controllers (e.g., the controller 910) of embodiments of the present disclosure. According to embodiments, the memory 970 and the memory of the at least one processor may be a same memory or different memories.

The controller 910 may control the temperature of the heater 950 by controlling supplying electric power of the battery 940 to the heater 950. For example, the controller 910 may control supply of electric power by controlling switching of a switching device between the battery 940 and the heater 950. In another example, a direct heating circuit may control supply of electric power to the heater 950 according to a control command of the controller 910.

The controller 910 may analyze a result detected by the sensing unit 920, and may control subsequent processes to be performed. For example, the controller 910 may control electric power supplied to the heater 950 to initiate or end an operation of the heater 950, based on a result detected by the sensing unit 920. In another example, the controller 910 may control an amount of electric power supplied to the heater 950 and a time at which electric power is supplied, based on a result detected by the sensing unit 920, so that the heater 950 is heated to a predetermined temperature or maintained at an appropriate temperature.

The controller 910 may control the output unit 930 based on a result detected by the sensing unit 920. For example, when the number of puffs counted through the puff sensor 926 reaches a predetermined number, the controller 910 may notify a user that the aerosol generating device 900 will soon be terminated, through at least one of the display unit 932, the haptic unit 934, and the sound output unit 936.

An embodiment may also be implemented in the form of a recording medium (e.g., a non-transitory computer readable medium) including instructions executable by a computer, such as a program module executable by the computer. The computer-readable medium may be any available medium that can be accessed by a computer and includes both volatile and nonvolatile media, and removable and non-removable media. In addition, the computer-readable medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium may include computer-readable instructions, data structures, other data in modulated data signals such as program modules, or other transmission mechanisms, and includes any information transfer media.

The descriptions of the above-described embodiments are merely examples, and it will be understood by those of ordinary skill in the art that the present disclosure includes various changes and equivalents of the example embodiments.

1. An aerosol generating device comprising:
a heater configured to heat an aerosol generating material; and
a controller configured to control supply of electric power to the heater, according to a predetermined temperature profile,
wherein the controller is further configured to detect puffs of a user, and change the predetermined temperature profile based on a time interval between the detected puffs.

2. The aerosol generating device of claim 1, wherein the controller is further configured to, based on the time interval between the puffs being less than a threshold value, control the supply of electric power by following a target temperature of the predetermined temperature profile at a second feedback control speed greater than a predetermined first feedback control speed.

3. The aerosol generating device of claim 2, wherein the controller is further configured to, based on the time interval between the puffs being greater than or equal to the threshold value, control the supply of electric power by following the target temperature of the predetermined temperature profile at a third feedback control speed less than the predetermined first feedback control speed.

4. The aerosol generating device of claim 1, wherein the controller comprises a proportional-integral-derivative (PID) control module configured to follow a target temperature of the predetermined temperature profile, and is further configured to change at least one gain value of the PID control module according to the time interval between the puffs.

5. The aerosol generating device of claim 1, wherein the controller is further configured to, based on the time interval between the puffs being less than a threshold value, control the supply of electric power by following a target temperature corresponding to a time t−1 ahead of a time t in the predetermined temperature profile in which a target temperature according to the time t is set.

6. The aerosol generating device of claim 5, wherein the controller is further configured to, based on the time interval between the puffs being greater than or equal to the threshold value, control the supply of electric power by following a target temperature corresponding to a time t+1 later than the time t.

7. The aerosol generating device of claim 1, wherein the controller is further configured to change the predetermined temperature profile from a time of an (N+1)^{th} puff, based on a time interval between consecutive puffs among a first puff to an N^{th} puff, wherein N is a natural number of 2 or more.

8. The aerosol generating device of claim 7, wherein the controller is further configured to change the predetermined temperature profile from a time of a fourth puff, based on an average time interval of a first time interval and a second time interval, the first time interval being between the first puff and a second puff, and the second time interval being between the second puff and a third puff.

9. The aerosol generating device of claim 1, further comprising a memory configured to store puff pattern data corresponding to the time interval between the puffs that are detected, wherein the controller is further configured to load the puff pattern data stored in the memory, and change the predetermined temperature profile based on the puff pattern data.

10. The aerosol generating device of claim 1, wherein the controller is configured to control the supply of electric power to the heater to reach a changed target temperature in the predetermined temperature profile.

11. A method performed by an aerosol generating device for controlling the aerosol generating device, the method comprising:
controlling supply of electric power to a heater of the aerosol generating device according to a predetermined temperature profile;
detecting puffs of a user; and
changing the predetermined temperature profile based on a time interval between the detected puffs.

12. The method of claim 11, wherein the changing of the predetermined temperature profile comprises:
based on the time interval between the puffs being less than a threshold value, changing the predetermined temperature profile such that the controlling of the supply of electric power is performed by following a target temperature of the predetermined temperature profile at a second feedback control speed greater than a predetermined first feedback control speed; and
based on the time interval between the puffs being greater than or equal to the threshold value, changing the predetermined temperature profile such that the controlling of the supply of electric power is performed by following the target temperature of the predetermined temperature profile at a third feedback control speed less than the predetermined first feedback control speed.

13. The method of claim 12, wherein the changing of the predetermined temperature profile further comprises changing at least one gain value of a proportional-integral-derivative (PID) control module, implemented by a controller of the aerosol generating device, the PID control module configured to follow the target temperature of the predetermined temperature profile according to the time interval between the puffs.

14. The method of claim 11, wherein the changing of the predetermined temperature profile comprises:
based on the time interval between the puffs being less than a threshold value, changing the predetermined temperature profile such that the controlling of the supply of electric power is performed by following a target temperature corresponding to a time t−1 ahead of a time t in the predetermined temperature profile in which a target temperature according to the time t is set; and
based on the time interval between the puffs being greater than or equal to the threshold value, changing the predetermined temperature profile such that the controlling of the supply of electric power is performed by following a target temperature corresponding to a time t+1 later than the time t.

15. The method of claim 11, further comprising:
storing puff pattern data corresponding to the time interval between the puffs that are detected,
wherein the changing the predetermined temperature profile comprises loading the puff pattern data, that is stored, and changing the predetermined temperature profile based on the puff pattern data.
